(19) United States
(12) Patent Application Publication
(10) Pub. No.: US 2019/0068263 A1
(43) Pub. Date: Feb. 28, 2019

(54) Method for Uplink Beam Training and Determination for Wireless Communication System with Beamforming

(71) Applicant: MEDIATEK INC., Hsinchu (TW)

(72) Inventors: Chia-Hao Yu, Hsinchu (TW); Weidong Yang, San Jose, CA (US); Ming-Po Chang, Hsinchu (TW); Cheng-Rung Tsai, Hsinchu (TW); Jiann-Ching Guey, Hsinchu (TW)

(21) Appl. No.: 16/108,765

(22) Filed: Aug. 22, 2018

Related U.S. Application Data
(60) Provisional application No. 62/548,973, filed on Aug. 23, 2017.
(60) Provisional application No. 62/567,014, filed on Oct. 2, 2017.

(51) Int. Cl. H04B 7/06; H04L 5/00; H04W 72/04; H04W 24/10; H04W 16/28

(52) U.S. Cl. CPC H04B 7/0617; H04L 5/0048; H04W 16/28; H04W 24/10; H04W 72/046

(57) ABSTRACT

A method of configuring different uplink beam management (UL BM) procedures is proposed. Different UL BM procedures are defined such that UE knows how to transmit the configured uplink reference signal (UL RS) over UL RS resource groups to BS. A first UL BM procedure enables UE to transmit with sweeping TX beams and enables BS to measure with sweeping RX beams (U-1 procedure). A second UL BM procedure enables UE to transmit UL RS on a number of UL resources with a fixed UE TX beam (U-2 procedure). A third UL BM procedure enables UE to transmit UL RS on a number of UL resources with different UE TX beams (U-3 procedure).

### CROSS REFERENCE TO RELATED APPLICATIONS

This application claims priority under 35 U.S.C. § 119 from U.S. Provisional Application No. 62/548,973, entitled “UE TX Beam Combination Determination for Beamforming System,” filed on Aug. 23, 2017; U.S. Provisional Application No. 62/567,014, entitled “Mechanism for UL Beam Indication,” filed on Oct. 2, 2017; the subject matter of which is incorporated herein by reference.

### TECHNICAL FIELD

The disclosed embodiments relate generally to wireless communication, and, more particularly, to beam management and reporting in a Millimeter Wave (mmWave) beamforming system.

### BACKGROUND

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

With recent advances in mmWave semiconductor circuitry, mmWave wireless system has become a promising solution for real implementation. However, the heavy reliance on directional transmissions and the vulnerability of the propagation environment present particular challenges for the mmWave network. In general, a cellular network system is designed to achieve the following goals: 1) Serve many users with widely dynamical operation conditions simultaneously; 2) Robust to the dynamics in channel variation, traffic loading and different QoS requirement; and 3) Efficient utilization of resources such as bandwidth and power. Beamforming adds to the difficulty in achieving these goals.

In principle, beam training mechanism, which includes both initial beam alignment and subsequent beam tracking, ensures that base station (BS) beam and user equipment (UE) beam are aligned for data communication. In downlink DL-based beam management (BM), the BS side provides opportunities for UE to measure beamformed channel of different combinations of BS beams and UE beams. For example, BS performs periodic beam sweeping with reference signal (RS) carried on individual BS beams. UE can collect beamformed channel state by using different UE beams and report the collect information to BS. Similarly, in uplink UL-based BM, the UE side provides opportunities for BS to measure beamformed channel of different combinations of UE beams and BS beams. For example, the UE performs periodic beam sweeping with reference signal (RS) carried on individual UE beams. BS can collect beamformed channel state by using different BS beams and report the collect information to the UE.

A fundamental question is how to decide a proper beam pair link (BPL) between a BS and a UE for communication. From UE perspective, when applying beamforming weight, the UE can be equipped with one or multiple antenna panels and each antenna panel can be consisted of cross-polarized antennas or co-polarized antennas of a single polarization. When applying beamforming weight, for each panel, a single 1-port beam or a single 2-port beam or two 1-port beams can be realized. When the BS needs to determine multiple UL BPLs for higher rank transmission or multi-TRP transmission, enough information needs to be provided to the BS so that the BS does not select UE TX beams that cannot be realized at the same time.

Before BS determines multiple UL BPLs for UE, UL beam training should be performed. In the course of the UL beam training, BS learns the constraints as well as UL beamformed channels corresponding to different UL BPLs. UL beam training involves UL RS resource configuration for UE. Different UL beam management procedures need to be defined such that UE knows how to transmit the configured UL RS.

### SUMMARY

In a first novel aspect, a method of antenna capability signaling and group-based reference signal resource configuration is proposed. UE provides its antenna capability signaling to BS to facilitate the UL beam training. From UE perspective, different antenna structures can be assumed and different beamforming mechanisms can be achieved based on the antenna structures. When BS determines multiple UL beam pair links (BPLs), BS needs to know the UE antenna capability information. In a preferred embodiment, group-based UL RS resources are configured for UL beam determination based on the UE antenna capability signaling, which helps BS to learn the UE beamforming constraints as well as UL beamformed channels corresponding to the UL BPLs.

In one embodiment, a UE transmits antenna capability from the UE to a base station in a beamforming wireless communication network. The UE receives beam management configuration for uplink (UL) reference signal (RS) resource allocation. A plurality of UL RS resources is grouped into multiple RS resource groups based on the UE antenna capability. The UE groups a plurality of UE TX beams into multiple beam groups. Each beam group is associated with an UL RS resource group. The UE transmits reference signals from the multiple RS resource groups to the BS using corresponding UE TX beams in the associated beam groups.

In another embodiment, a BS receives antenna capability of a user equipment (UE) from the UE in a beamforming wireless communication network. The BS transmits beam management configuration for reference signal (RS) resource allocation. A plurality of RS resources is grouped into multiple RS resource groups based on the UE antenna capability. The BS measuring reference signals transmitted by the UE from the multiple RS resource groups using corresponding UE TX beams belonging to associated UE beam groups. The BS determines uplink beam pair links (BPLs) based on the measurement results of the reference signals.

In a second novel aspect, a method of configuring different uplink beam management (UL BM) procedures is proposed. Different UL BM procedures are defined such that UE knows how to transmit the configured uplink (UL) reference signals (RSs) over UL RS resource groups to BS. A first UL BM procedure enables UE to transmit with sweeping TX beams and enables BS to measure with sweeping RX beams (U-1 procedure). A second UL BM procedure enables UE to transmit UL RS on a number of UL resources with a fixed UE TX beam (U-2 procedure). A third UL BM procedure enables UE to transmit UL RS on a number of UL resources with different UE TX beams (U-3 procedure).

In one embodiment, a UE receives uplink beam management (UL BM) configuration in a beamforming wireless communication network. The UL BM configuration comprises allocated reference signal (RS) resources for an UL BM procedure. The UE transmits reference signals to the base station in accordance with the UL BM procedure using a selected set of UE beams over the allocated RS resources. The UL BM procedure is determined based on the UL BM configuration and whether a trigger signaling is received. The UE receives one or multiple determined beam pair links (BPLs) from the base station for subsequent uplink transmission.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a Millimeter Wave beamforming wireless communication system with uplink beam training and determination in accordance with one novel aspect.

FIG. 2 is a simplified block diagram of a base station and a user equipment that carry out certain embodiments of the present invention.

FIG. 3 illustrates a procedure for uplink (UL) beam determination with UE antenna capability signaling in accordance with one novel aspect.

FIG. 4 illustrates examples of UE antenna capability for UL beam determination.

FIG. 5 illustrates a first embodiment of UE antenna capability signaling and group-based UL RS resource configuration.

FIG. 6 illustrates a second embodiment of UE antenna capability signaling and group-based UL RS resource configuration.

FIG. 7A is a flow chart of a method of uplink beam determination from UE perspective in a beamforming wireless network in accordance with one novel aspect.

FIG. 7B is a flow chart of a method of uplink beam determination from BS perspective in a beamforming wireless network in accordance with one novel aspect.

FIG. 8 illustrates different uplink (UL) beam management (BM) procedures supporting beam determination in accordance with one novel aspect.

FIG. 9 illustrates a sequence flow of an UL BM procedure in accordance with one novel aspect.

FIG. 10 illustrates one embodiment of configuring UL BM procedure U-1.

FIG. 11 illustrates one embodiment of configuring UL BM procedure U-2 or U-3.

FIG. 12 is a flow chart of a method of configuring uplink beam management in a beamforming wireless network in accordance with one novel aspect.

### DETAILED DESCRIPTION

Reference will now be made in detail to some embodiments of the invention, examples of which are illustrated in the accompanying drawings.

FIG. 1 illustrates a Millimeter Wave beamforming wireless communication system 100 with uplink beam training and beam determination in accordance with one novel aspect. Beamforming mmWave mobile communication network 100 comprises a base station BS 101 and a user equipment UE 102. The mmWave cellular network 100 uses directional communication with narrow beams and can support multi-gigabit data rate. Directional communication is achieved via digital and/or analog beamforming, wherein multiple antenna elements are applied with multiple sets of beamforming weights to form multiple beams. Different beamformers can have different spatial resolution, i.e., beamwidth. For example, a sector antenna can form beams having lower array gain but wider spatial coverage, while a beamforming antenna can have higher array gain but narrower spatial coverage.

The purpose of downlink (DL) and uplink (UL) beam training is to decide a proper beam pair link (BPL) between a BS and a UE for communication. In uplink UL-based beam management, the UE side provides opportunities for BS to measure beamformed channel of different combinations of UE beams and BS beams. For example, UE performs periodic beam sweeping with reference signal (RS) carried on individual UE beams. BS can collect beamformed channel state by using different BS beams and report the collected information to UE. In the example of FIG. 1, BS 101 provides uplink (UL) RS resource configuration for UL beam management. UE 102 then transmits UL RS using different UE TX beams over the configured UL RS resources. BS 101 performs measurements and reports one or more BPLs with corresponding measurement metric(s).

In according with one novel aspect, UE 102 provides its antenna capability signaling to BS 101 to facilitate the UL beam training. From UE perspective, different antenna structures can be assumed and different beamforming mechanisms can be achieved based on the antenna structures. When BS determines multiple UL BPLs, BS needs to know the UE antenna capability information. In a preferred embodiment, group-based UL RS resources are configured for UL beam determination, which helps BS to learn the UE beamforming constraints as well as UL beamformed channels corresponding to the UL BPLs. In one example, UE 102 transmits UL RS#2 from RS group #1 using UE TX beam #3 in panel #2, and transmits UL RS#8 from RS group #2 using UE TX beam #6 in panel #1.

In accordance with another novel aspect, different UL beam management (BM) procedures are defined such that UE knows how to transmit the configured UL RS to BS. A first UL BM procedure enables UE to transmit with sweeping TX beams and enables BS to measure with sweeping RX beams (U-1 procedure). A second UL BM procedure enables UE to transmit UL RS on a number of UL resources with a fixed UE TX beam (U-2 procedure). A third UL BM procedure enables UE to transmit UL RS on a number of UL resources with different UE TX beams (U-3 procedure).

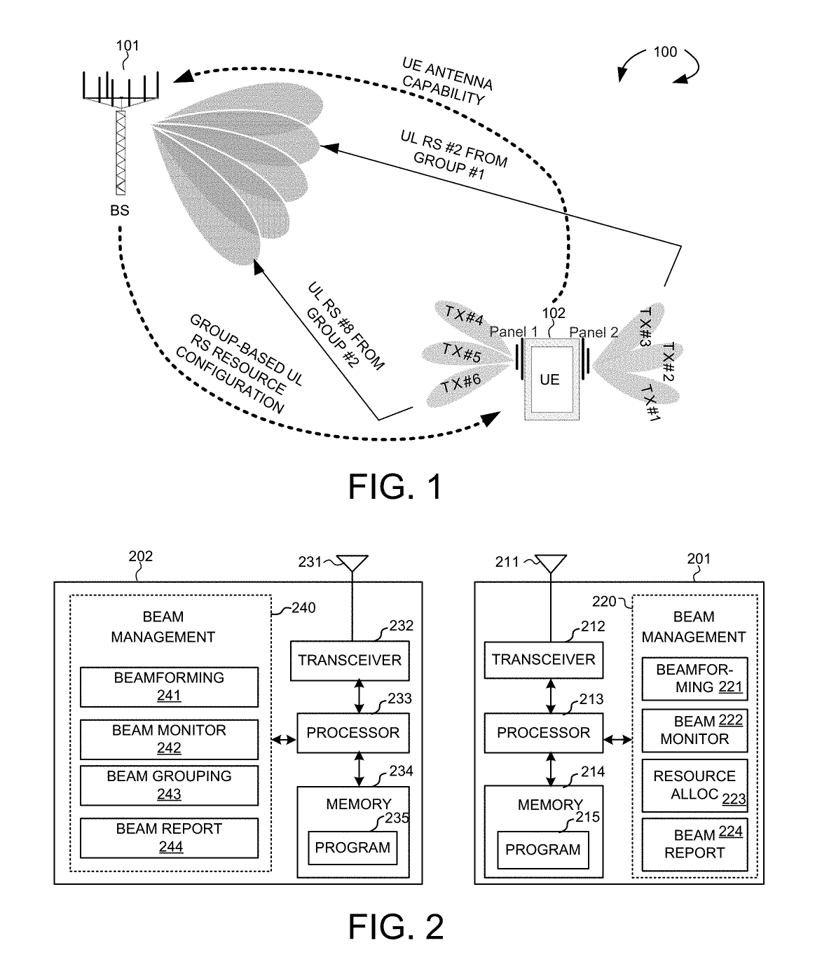

FIG. 2 is a simplified block diagram of a base station and a user equipment that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules that carry out different tasks in accordance with embodiments of the current invention.

Similarly, UE 202 has an antenna 231, which transmits and receives radio signals. A RF transceiver module 232, coupled with the antenna, receives RF signals from antenna 231, converts them to baseband signals and sends them to processor 233. RF transceiver 232 also converts received baseband signals from processor 233, converts them to RF signals, and sends out to antenna 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, BS 201 comprises a beam management module 220, which further comprises a beamforming circuit 221, a beam monitor 222, and a beam reporting circuit 223. Beamforming circuit 221 may belong to part of the RF chain, which applies various beamforming weights to multiple antenna elements of antenna 211 and thereby forming various beams. Beam monitor 222 monitors received radio signals and performs measurements of the radio signals transmitted over the various UE beams. Resource allocation circuit 223 allocates RS resource groups based on UE antenna capability, configures and triggers different UL BM procedures, and beam report circuit provides determined BPLs to UE.

Similarly, UE 202 comprises a beam management module 240, which further comprises a beamforming circuit 241, a beam monitor 242, a beam grouping circuit 243, and a beam feedback circuit 244. Beamforming circuit 241 may belong to part of the RF chain, which applies various beamforming weights to multiple antenna elements of antenna 231 and thereby forming various beams. Beam monitor 242 monitors received radio signals and performs measurements of the radio signals over the various beams. Beam grouping circuit groups different BS beams into beam groups based on RS resource configuration. Beam report circuit 244 provide beam quality metric and send report to BS 201 in beam groups based on the beam monitoring results for each BS beam. Overall, beam management circuit 240 performs UL beam training and management procedures to provide UE antenna capability, to transmit reference signals over configured RS resources over different UE beams, and to enable BS to determine selected BPLs for subsequent data transmission.

### UL Beam Determination

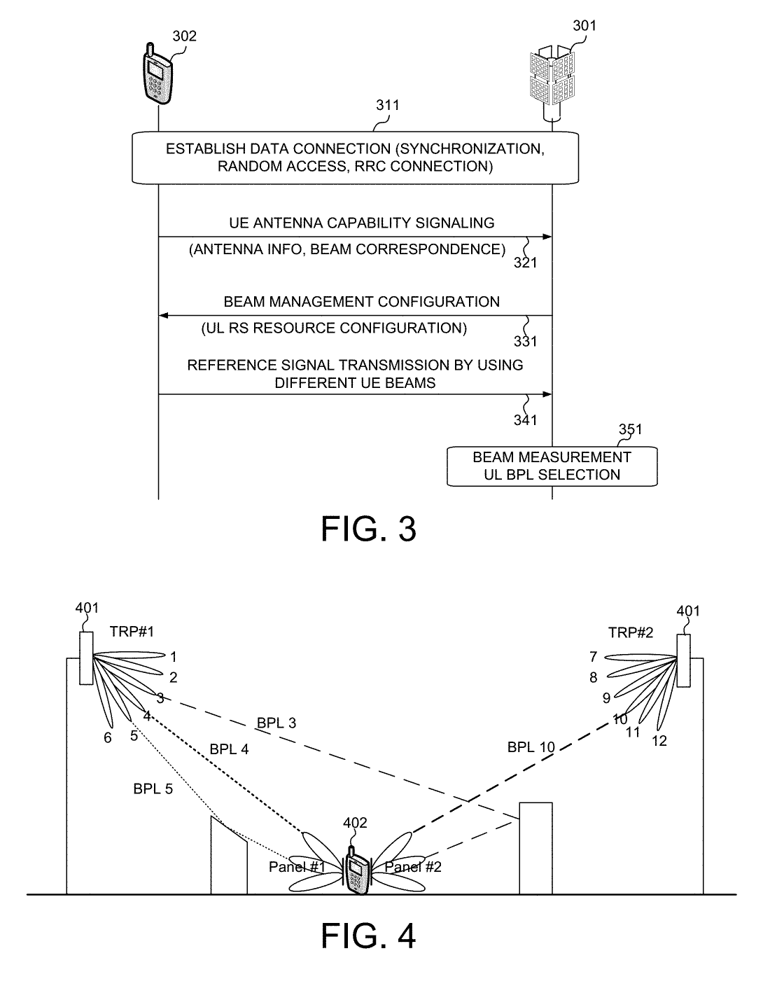

FIG. 3 illustrates a procedure for uplink (UL) beam determination with UE antenna capability signaling in accordance with one novel aspect. Initially, UE 302 performs scanning, beam selection, and synchronization with BS 301 using periodically configured control beams. In step 311, BS 301 and UE 302 establish a data connection over a trained dedicated data beam based on a beam training operation (after performing synchronization, random access, and RRC connection establishment). In step 321, UE 302 provides UE antenna capability signaling to BS 301. The antenna capability information comprises number of required UL RS resource groups, i.e., a number of UE antenna groups or panels, a number of UE beams per group, and beam correspondence state. When BS needs to determine multiple UL BPLs for higher rank transmission or multi-TRP transmission, enough information needs to be provided to BS so that BS does not select UE TX beams that cannot be realized at the same time.

In step 331, BS 301 provides beam management configuration to UE 302 based on the UE antenna capability. The beam management configuration comprises UL RS resource configuration, UL RS transmission information, etc. For example, BS 301 configures group-based UL RS resources for UE 302. In step 341, UE 302 periodically transmits UL RS to BS 301 using different UE beams over the group-based UL RS resources. Based on the group-based UL RS transmission, BS 301 recursively monitors and measures the UE beams for its RSRP and/or CSI metric (step 351). BS 301 learns the UE beam constraint after UL beam training, and then determines multiple UL BPLs for higher rank transmission or multi-TRP transmission.

FIG. 4 illustrates examples of UE antenna capability for UL beam determination. From UE perspective, when applying beamforming weight, it can be equipped with one or multiple antenna panels and each antenna panel can be consisted of cross-polarized antennas or co-polarized antennas of a single polarization. When applying beamforming weight, for each panel, a single 1-port beam or a single 2-port beam or two 1-port beams can be realized. During UE TX beamforming, the following constraints can be assumed: different 2-port beams on a same cross-polarized panel cannot be realized by UE simultaneously, different 1-port beams on a same co-polarized panel cannot be realized by UE simultaneously. On the other hand, different 2-port beams on different cross-polarized panels and different 1-port beams on a same cross-polarized panel can be realized by UE simultaneously.

In the example of FIG. 4, BS 401 has two transmission points (TRP#1 and TRP#2) and twelve TX beams, beams #1-6 are transmitted from TRP#1, and beams #7-12 are transmitted from TRP#2. UE 402 has two antenna panels—UE panel#1 and UE panel#2. As depicted, BPL #3 and BPL #10 correspond to UE panel#2, while BPL #4 and BPL #5 correspond to UE panel#1. As a result, UE TX beams corresponding to {BPL 3, BPL 10} or {BPL 4, BPL 5} cannot be realized at the same time, while UE TX beams corresponding to {BPL 4, BPL 10} or {BPL 3, BPL 5} can be realized at the same time. Based on such antenna information, BS can configure UL RS resources accordingly for UL beam determination.

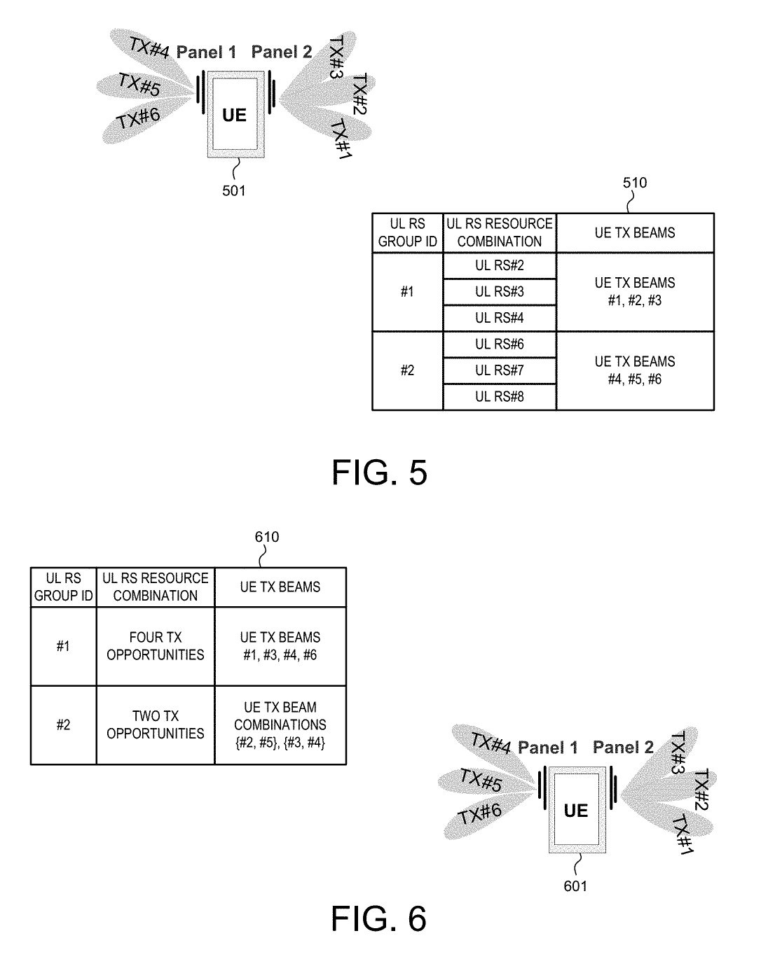

FIG. 5 illustrates a first embodiment of UE antenna capability signaling and group-based UL RS resource configuration. Assume BS knows UE antenna capability, e.g., from capability signaling, the number of antenna groups or panels and the number of UL RS resources required to select a beam for a panel. The number of UL RS resources can be smaller than the number of totally realizable beams in a panel. For example, if beam correspondence holds, the result from DL beam management can be leveraged for reducing the number. If beam correspondence holds only imperfectly, the result from DL beam management and UL beam uncertainty level based on UE RX beam can be leveraged for reducing the number.

BS can configure grouped UL RS resources for UL beam determination for higher rank transmission or multi-panel/TRP transmission. From UE perspective, UE uses UL RS resources for UL beam training. In one example, for UE TX beams that cannot be transmitted at the same time, they are applied on UL RS resources from a same group; for UE TX beams that can be transmitted at the same time, they are applied on UL RS resources from different groups. In another opposite example, for UE TX beams that can be transmitted at the same time, they are applied on UL RS resources from a same group; for UE TX beams that cannot be transmitted at the same time, they are applied on UL RS resources from different groups.

In the example of FIG. 5, UE 501 has the antenna structure of UE TX beams #1, #2, and #3 cannot be transmitted at the same time, and UE TX beams #4, #5, and #6 cannot be transmitted at the same time. As depicted in Table 510, two groups of UL RS resources are configured for UE 501: a first group #1 of {UL RS #2, UL RS #3, UL RS #4} and a second group #2 of {UL RS #6, UL RS #7, UL RS #8}. BS can signal the UL RS resource group ID, and the UL RS resource combination indication for the selected UL RS resource group. As a result, UE TX beams #1, #2 and #3 are applied on UL RS resource group #1 {UL RS #2, UL RS #3, UL RS #4}, and UE TX beams #4, #5 and #6 are applied on UL RS resource group #2 {UL RS #6, UL RS #7, UL RS #8}. The associations between UL RS resource groups and UE TX beams can be up to UE. With this solution, the BS can learn the UE TX beam constraints after UL beam training based on the UL RS resources transmission.

FIG. 6 illustrates a second embodiment of UE antenna capability signaling and group-based UL RS resource configuration. Assume BS knows UE antenna capability, e.g., from capability signaling, the number of antenna groups or panels and the number of UL RS resources required to select a beam for a panel. BS can configure one or multiple groups of UL RS resources. In each group of UL RS resources, UE TX beam selection for UL RS transmission is restricted. For example, the number of simultaneous UE TX beams can be restricted, which can be equivalent to the maximally realizable transmission rank. In each group of UL RS resources, one or multiple transmission opportunities are possible. Each transmission opportunity can correspond to different combinations of simultaneous UE TX beams. The selection of UE TX beam combination can be up to UE and can be based on the result of DL beam management. The result of DL beam management can be directly applied in case of beam correspondence, or can be used to determine a set of possible UE TX beam combinations in case of imperfect beam correspondence.

In the example of FIG. 6, two groups of UL RS resources are configured for UE 601. A first group of UL RS resources is a 1-beam group, and a second group of UL RS resources is a 2-beam group. In 1-beam group, there are four transmission opportunities, and UE 601 selects four UE TX beams (e.g., UE TX beams #1, #3, #4, #6) for UL RS transmission. In 2-beam group, there are two transmission opportunities, and UE 601 selects two 2-beam combinations (e.g., UE TX 2-beam combination {#2, #5} and 2-beam combination {#3, #4}) for UL RS transmission, wherein UE TX beams in a same 2-beam combinations can be transmitted simultaneously. With this solution, the BS can learn the beamformed channel information of four 1-beam channel, and two 2-beam channels based on the UL RS transmissions for UL beam training.

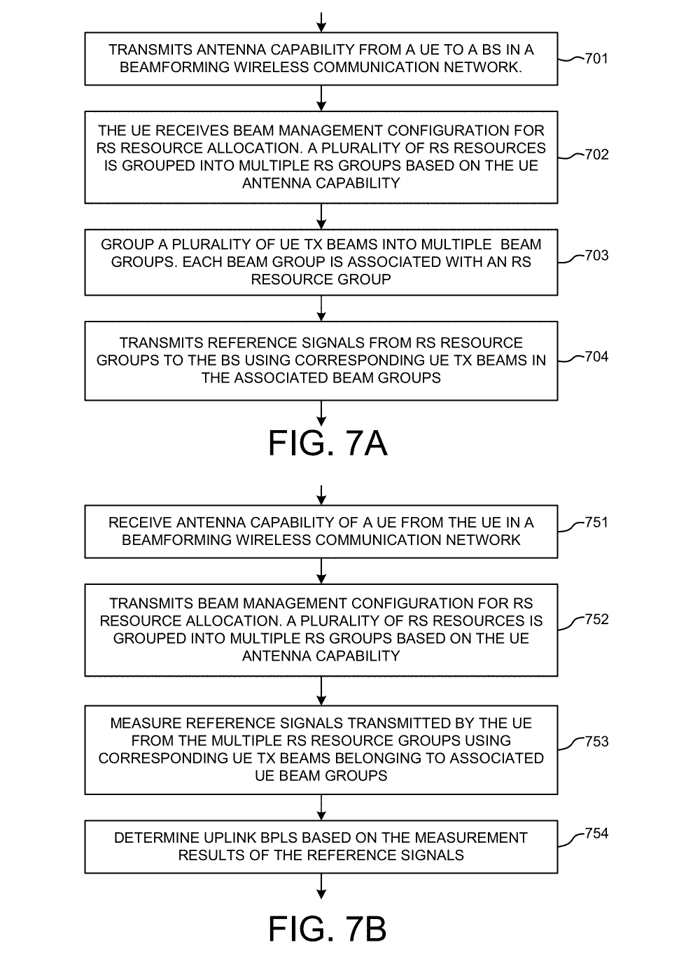

FIG. 7A is a flow chart of a method of uplink beam determination from UE perspective in a beamforming wireless network in accordance with one novel aspect. In step 701, a UE transmits antenna capability from the UE to a base station in a beamforming wireless communication network. In step 702, the UE receives beam management configuration for reference signal (RS) resource allocation. A plurality of RS resources is grouped into multiple RS resource groups based on the UE antenna capability. In step 703, the UE groups a plurality of UE TX beams into multiple beam groups. Each beam group is associated with an RS resource group. In step 704, the UE transmits reference signals from RS resource groups using corresponding UE TX beams in the associated beam groups.

FIG. 7B is a flow chart of a method of uplink beam determination from BS perspective in a beamforming wireless network in accordance with one novel aspect. In step 751, a BS receives antenna capability of a user equipment (UE) from the UE in a beamforming wireless communication network. In step 752, the BS transmits beam management configuration for reference signal (RS) resource allocation. A plurality of RS resources is grouped into multiple RS resource groups based on the UE antenna capability. In step 753, the BS measuring reference signals transmitted by the UE from the multiple RS resource groups using corresponding UE TX beams belonging to associated UE beam groups. In step 754, the BS determines uplink beam pair links (BPLs) based on the measurement results of the reference signals.

### Uplink Beam Management Procedures

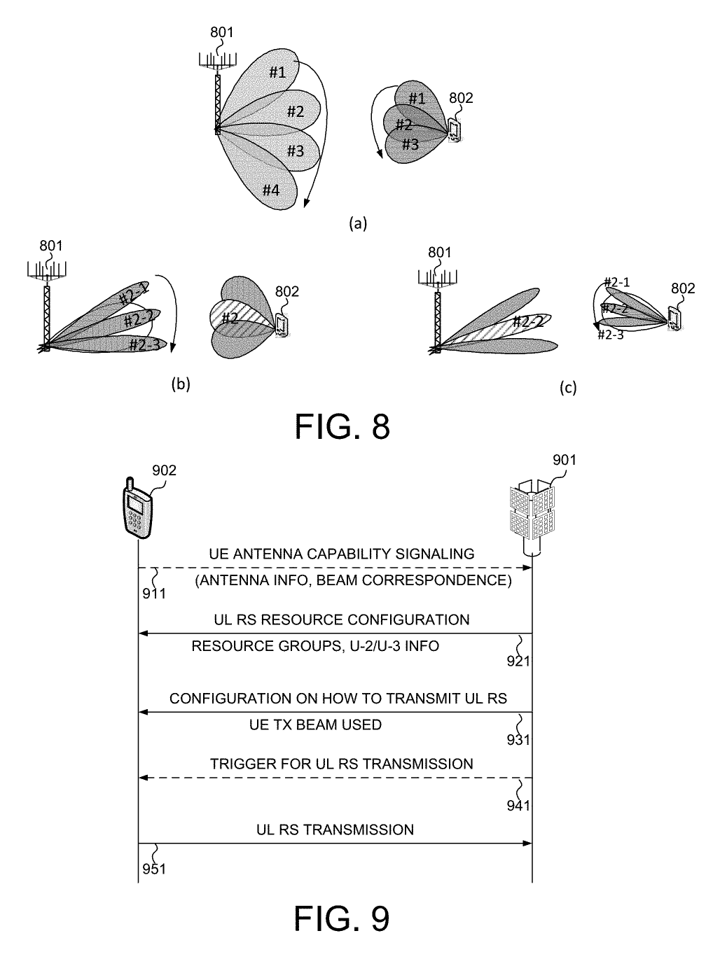

FIG. 8 illustrates different uplink (UL) beam management (BM) procedures supporting beam determination in accordance with one novel aspect. As depicted by FIG. 8(a), a first UL BM procedure enables UE 802 to transmit with sweeping UE TX beams #1-#4 and enables BS 801 to measure with sweeping BS RX beams #1-#4 (U-1). U-1 can be configured as a periodic UL BM procedure, including UL RS configuration containing UL RS resource groups. As depicted by FIG. 8(b), a second UL BM procedure enables UE 802 to transmit UL RS on a number of UL resources with a fixed UE TX beam #2, while BS 801 may use different BS RX beams #2-1-#2-3 (U-2). Application of a fixed UE TX beam and application of which UE TX beam as the fixed UE TX beam can be signaled from the network. As depicted by FIG. 8(c), a third UL BM procedure enables UE 802 to transmit UL RS on a number of UL resources with different UE TX beams #2-1-#2-3, while BS 801 may use a fixed BS RX beam #2-2 (U-3). UL beam indication, e.g., UL beam and UL RS resource index, is signaled to UE with indication to trigger the U-3 procedure.

FIG. 9 illustrates a sequence flow of an UL beam management procedure in accordance with one novel aspect. In step 911, UE 902 optionally provides UE antenna capability signaling to BS 901. The antenna capability information may comprise number of required UL RS resource groups, i.e., number of UE antenna groups or panels, number of UE beams per group, and beam correspondence state. In step 921, BS 901 provides UL RS resource configuration comprising number of resource groups, number of resources per group, whereabouts of resources, and U-2/U-3 information. The configuration can be via RRC or MAC-CE signaling. In step 931, BS 901 provides configuration on how to transmit the configured UL RS resource, i.e., UE TX beam(s) used for UL RS transmission. In one example, the configuration notifies UE whether to apply a fixed UE TX beam across UL RS resources within a same UL RS resource group or not. For U-2, which UE TX beam to apply is signaled by BS 901. For U-3, UE TX beams are up to UE implementation or based on network signaling. In step 941, BS 901 optionally triggers for non-periodic UL RS transmission. The signaling can be via MAC-CE signaling or via DCI with or without UL grant. The signaling can provide information on which UE TX beam(s) to apply for the UL RS transmission, implicitly or explicitly. In step 951, UE 902 performs corresponding UL RS transmission based on configuration and/or aperiodic trigger.

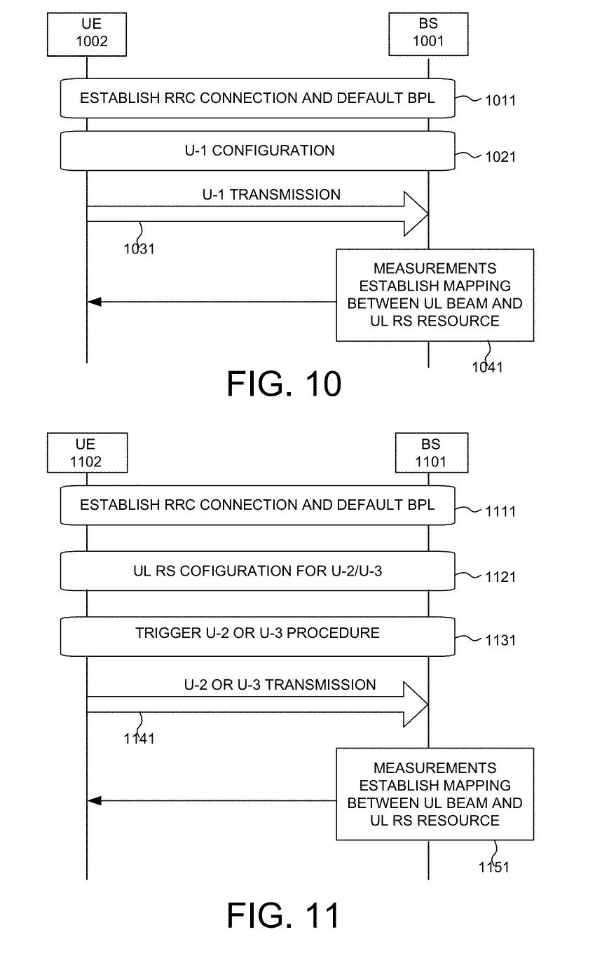

FIG. 10 illustrates one embodiment of configuring UL beam management procedure U-1. In step 1011, BS 1001 and UE 1002 establish an RRC connection and default BPL. In step 1021, U-1 procedure is configured, e.g., via RRC message. During U-1, BS is able to sweep through its BS RX beams for BM while UE is able to sweep through its UE TX beams for UL RS transmission. U-1 can be configured as a periodic UL BM procedure with UL RS configuration. The U-1 configuration can include information on whether a fixed UE TX beam is used for UL RS resources within an UL RS group but different UE TX beams for UL RS resources within different UL RS resource group. Or vice versa, i.e., different UE TX beams are applied for UL RS resources within an UL RS resource group, but same set of UE TX beams is applied for individual UL RS resource group. The information can be implicitly signaled, e.g., by following a predefined rule. In step 1031, UE 1002 transmits UL RS based on the U-1 configuration. In step 1041, BS 1001 performs measurements and selects a subset of UL RS resources to be associated with UL BPLs. The mapping is established by BS 1001 and then signaled to UE 1002. BS 1001 can trigger U-2 and/or U-3 for further UL BM on adjacent or refined beams.

FIG. 11 illustrates one embodiment of configuring UL beam management procedure U-2 or U-3. In step 1111, BS 1101 and US 1102 establish an RRC connection and default BPL. The DL and UL default BPLs are identified during RACH procedure before entering RRC-Connected mode. The default BPL may be mapped to a default beam indication state, e.g., 000. In step 1121, BS 1101 configures UL RS resources for U-2 and/or U-3 procedure. In step 1131, BS 1101 triggers the U-2 and/or U-3 procedure. In step 1141, UE 1102 transmits UL RS based on the U-2 and/or U-3 configuration. In step 1151, BS 1101 performs measurements and selects a subset of UL RS resources to be associated with UL BPLs. Note that both DL and UL BM procedures are applied for UL beam determination. The mapping between UL beam indication and UL BM RS resources is established by BS 1101 and then signaled to UE 1102. BS 1101 can subsequently trigger more U-2 and/or U-3 procedures for additional beam refining or beam tracking, with UL beam indication provided in the trigger signaling.

For U-2, the application of a fixed UE TX beam and which UE TX beam as the fixed UE TX beam can be signaled as in the following two examples. In a first example, UL RS configuration includes information of whether a fixed UE TX beam is used for a configured UL RS resource group. In one example, individual UL RS resources in an UL RS resource group are single-symbol UL RS resources. The group configuration contains an IE indicating whether repetition is “on” or “off”. If “on”, the UE may assume that a fixed UE TX beam is applied. If “off”, the UE does not need to assume a fixed UE TX beam is applied. The signaling that trigger UL transmission (e.g., via DCI signaling) on the UL RS resource group can additionally include information of which UE TX beam is to be applied for the UL transmission. When UE beam correspondence holds, the information of which UE TX beam for UL transmission is not included. In a second example, UL RS configuration contains a number of UL RS resource groups. The signaling (e.g., via DCI signaling) that triggers UL transmission on an UL RS resource group can be configured to include information of application of a fixed TX beam and of which UE TX beam is to be applied for the UL transmission.

For U-3, beam indication is signaled to UE with indication to trigger the procedure. In a first example, UL RS configuration includes information of whether a fixed UE TX beam is used for a configured UL RS resource group. In one example, individual UL RS resources in an UL RS resource group are single-symbol UL RS resources. The group configuration contains an IE indicating whether repetition is “on” or “off”. If “on”, the UE may assume that a fixed UE TX beam is applied. If “off”, the UE does not need to assume a fixed UE TX beam is applied. The signaling that triggers transmission on selected configured the UL RS resource group(s) is preferably via DCI signaling. Additional information on BS spatial filter setting for receiving the triggered UL RS transmission can be included in the signaling. The information on BS receiving setting can refer to an UL beam indication or a DL beam indication. In a second example, UL RS configuration contains a number of UL RS resource groups. The signaling that triggers UL transmission on the UL RS resource group can be configured to include information of application of different UE TX beams. The signaling is preferably via DCI signaling. Additional information on BS spatial filter setting for receiving the triggered UL RS transmission can be included in the signaling. The information on BS receiving setting can refer to an UL beam indication or a DL beam indication.

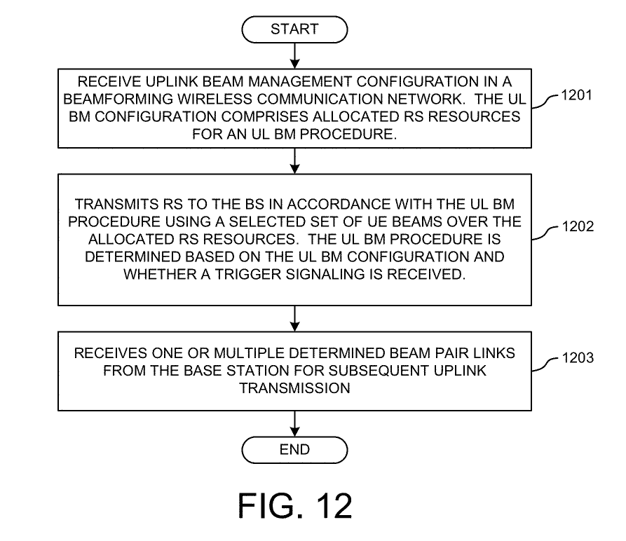

FIG. 12 is a flow chart of a method of configuring uplink beam management in a beamforming wireless network in accordance with one novel aspect. In step 1201, a UE receives uplink beam management (UL BM) configuration in a beamforming wireless communication network. The UL BM configuration comprises allocated reference signal (RS) resources for an UL BM procedure. In step 1202, the UE transmits reference signals to the base station in accordance with the UL BM procedure using a selected set of UE beams over the allocated RS resources. The UL BM procedure is determined based on the UL BM configuration and whether a trigger signaling is received. In step 1203, the UE receives one or multiple determined beam pair links (BPLs) from the base station for subsequent uplink transmission.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving uplink beam management (UL BM) configuration by a user equipment (UE) in a beamforming wireless communication network, wherein the UL BM configuration comprises allocated reference signal (RS) resources for an UL BM procedure;
transmitting reference signals to the base station in accordance with the UL BM procedure using a selected set of UE beams over the allocated RS resources, wherein the UL BM procedure is determined based on the UL BM configuration and whether a trigger signaling is received; and
receiving one or multiple determined beam pair links (BPLs) from the base station for subsequent uplink transmission.

2. The method of claim 1, wherein the UE identifies a first UL BM procedure based on periodically configured RS resources and an absence of the trigger signaling.

3. The method of claim 2, wherein the UE sweeps through a set of UE beams for the UL RS transmission.

4. The method of claim 1, wherein the UE identifies a second UL BM procedure where the UE receives the trigger signaling and the selected set of UE beams contains a fixed UE beam for the UL RS transmission.

5. The method of claim 4, wherein the UL BM configuration comprises an indication of applying the fixed UE beam.

6. The method of claim 4, wherein the trigger signaling comprises information of which UE beam is selected to be the fixed UE beam.

7. The method of claim 1, the UE identifies a third UL BM procedure where the UE receives the trigger signaling and the selected set of UE beams contains multiple UE beams for the UL RS transmission.

8. The method of claim 7, wherein the UL BM configuration comprises an indication of not applying a fixed UE beam.

9. The method of claim 7, wherein the trigger signaling comprises information on BS spatial filter setting for receiving the UL RS transmission.

10. The method of claim 1, wherein the determined BPLs are identified by RS resource indexes associated with corresponding UE TX beams.

11. A User Equipment (UE) comprising:
a receiver that receives uplink beam management (UL BM) configuration in a beamforming wireless communication network, wherein the UL BM configuration comprises allocated reference signal (RS) resources for an UL BM procedure;
a transmitter that transmits reference signals to the base station in accordance with the UL BM procedure using a selected set of UE beams over the allocated RS resources, wherein the UL BM procedure is determined based on the UL BM configuration and whether a trigger signaling is received; and
a beam management circuit that obtains one or multiple determined beam pair links (BPLs) from the base station for subsequent uplink transmission.

12. The UE of claim 11, wherein the UE identifies a first UL BM procedure based on periodically configured RS resources and an absence of the trigger signaling.

13. The UE of claim 12, wherein the UE sweeps through a set of UE beams for the UL RS transmission.

14. The UE of claim 11, wherein the UE identifies a second UL BM procedure where the UE receives the trigger signaling and the selected set of UE beams contains a fixed UE beam for the UL RS transmission.

15. The UE of claim 14, wherein the UL BM configuration comprises an indication of applying the fixed UE beam, and wherein the trigger signaling comprises information of which UE beam is selected to be the fixed UE beam.

16. The UE of claim 11, the UE identifies a third UL BM procedure where the UE receives the trigger signaling and the selected set of UE beams contains multiple UE beams for the UL RS transmission.

17. The UE of claim 16, wherein the UL BM configuration comprises an indication of not applying a fixed UE beam, and wherein the trigger signaling comprises information on BS spatial filter setting for receiving the UL RS transmission.

18. The UE of claim 11, wherein the determined BPLs are identified by RS resource indexes associated with corresponding UE TX beams.

19. A method comprising:
transmitting uplink beam management (UL BM) configuration by a base station in a beamforming wireless communication network, wherein the UL BM configuration comprises allocated reference signal (RS) resources for an UL BM procedure;
receiving reference signals from a user equipment (UE) in accordance with the UL BM procedure using a selected set of UE beams over the allocated RS resources, wherein the UL BM procedure is determined based on the UL BM configuration and whether a trigger signaling is transmitted; and
transmitting one or multiple determined beam pair links (BPLs) from the base station for subsequent uplink transmission.

20. The method of claim 19, wherein the determined BPLs are identified by RS resource indexes associated with corresponding UE TX beams.
